(19) United States
(12) Patent Application Publication
(10) Pub. No.: US 2012/0259854 A1
(43) Pub. Date: Oct. 11, 2012

(54) Conversion Path Based Segmentation

(75) Inventors: Sissie Ling-Ie HSIAO, Santa Clara, CA (US); Cameron Tangney, Sunnyvale, CA (US); Nicholas Seckar, Mountain View, CA (US); Brian Chatham, Pleasanton, CA (US)

(73) Assignee: Google Inc.

(21) Appl. No.: 13/084,530

(22) Filed: Apr. 11, 2011

(51) Int. Cl. G06F 17/30

(52) U.S. Cl. 707/739; 707/E17.046; 707/E17.047

(57) ABSTRACT

Methods, systems, and apparatus, including computer programs encoded on a computer storage medium including receiving user interaction data, wherein the user interaction specifies user interactions with content items and conversion items. A conversion item is a user action that satisfies a predetermined conversion criteria. The method includes receiving conversion data including conversion path data for a plurality of conversion paths, wherein each conversion path includes user interaction data prior to and including a conversion event. The method includes determining a first interaction, an assist interaction or a last interaction with content items for the conversion event. The method includes providing an ability to define a segment, using a processor, the conversion path data based on path-level dimensions and path-level metrics.

### BACKGROUND

The Internet provides access to a wide variety of content. For instance, images, audio, video, and web pages for many different topics are accessible through the Internet. The accessible content provides an opportunity to present advertisements to users. Advertisements can be placed within content, such as a web page, image or video, or the content can trigger the display of one or more advertisements, such as presenting an advertisement in an advertisement slot within the content and/or in an advertisement slot of a pop-up window or other overlay.

Advertisers decide which ads are displayed within particular types of content using various advertising management tools. These tools also allow an advertiser to track the performance of various advertisements (ads) or advertising campaigns (ad campaigns). The parameters used to determine when to display a particular ad can also be changed using advertising management tools.

The data that is used to generate the performance measures for the advertiser generally includes all data that is available. This data usually includes a combination of data from multiple servers. The combined data is large enough that performance measures generated from the data are needed to provide an efficient way of understanding the data. The data, therefore, must be processed. Processing of the data to generate useful and accurate performance measures involves a number of obstacles. For instance, if a performance measure is based upon a user's actions over a period of time, a cookie can be used to track a user's actions over a period of time. If this cookie is removed during the period of time, the data will not contain an accurate account of the user's actions during a period of time. The data can also contain recorded user actions that are deemed significant to an advertiser. These actions, which can be any recordable event, are called conversions. Conversions are attributable to a certain action or actions in a conversions path. Identifying those actions can be valuable to a content provider. The data, however, contains numerous actions that could be attributable to conversions. In addition, the data may also contain user actions that do not include any conversions. Thus, processing the data to provide accurate and reliable performance measures based upon all the possible actions has a number of challenges.

### SUMMARY

In general, one innovative aspect of the subject matter described in this specification can be embodied in methods that include receiving conversion path data that includes user interaction data. The method may further include assigning each interaction in the user interaction data one or more of a first interaction label, assist interaction label or a last interaction label. The method may group conversion path data according to at least one of a path-level dimension, path-level metric, interaction-level dimensions and interaction-level metric. A path-level dimension (dimension) may represent one or more characteristics of one or more interactions that are part of a conversion path. A dimension may be a variable that is assigned a character or string value based on the characteristics of the user interaction with the advertiser's content. A path-level metric (metric) may include a numerical characteristic of the entire conversion path. A metric may be a variable that is assigned an integer or floating value that characterizes the entire conversion path. Other embodiments of this aspect, include corresponding systems, apparatus, and non-transitory or tangible computer readable-media, configured to perform the actions of this method.

These and other embodiments can each optionally include one or more of the following features. The conversion event is an interaction that satisfies predetermined conversion criterion. Conversion path data can include a plurality of conversion paths. Each conversion path includes user interaction data prior to and including the conversion event. The method may include providing a user interface to define a condition to include or exclude a group of conversion paths. The assist interaction is any interaction by the user that occurs prior to the interaction that leads to the conversion event. The last interaction is an interaction by the user that leads to the conversion event. The user interaction data includes a source and a medium used by the user to reach the content items. The method includes filtering based on a particular type of interaction occurring prior to or after another type of interaction.

Particular embodiments of the subject matter described in this specification can be implemented so as to realize one or more of the following advantages. Conversion path based segmentation operates on the conversion path prior to the user getting to the advertiser's content. Conversion path based segmentation enables advertisers to understand and draw conclusions about cross channel advertising and return on investment. Using conversion path based data allows an advertiser to generate conditions that use custom dimensions and complex expressions, such as, (A or B) and (C or D and (E or not F)). Each letter in the earlier expression may represent a conversion path based metric and dimension or other more complex conditions. Moreover, a condition may specify values for an exposed dimension and metric, including path-level (e.g. time lag or path length) as well as interaction-level (e.g. source/medium) dimensions and metrics. Also the condition may contain nested conditions. The nested conditions may contain one or more metrics or dimensions. Conversion path based segmentation allows a content provider to isolate or compare conversion paths that match specified (often complex) criterion. For example, a content provider may apply a segment to conversion data and generate a report showing one or more conversion segments. Defining these complex expressions allows advertisers to view a subset of their conversions (or view many subsets in comparison with one another). A content provider may evaluate the users actions represented by the conversion paths in accordance to the criteria specified in the segmentation condition. For example, an expression may compare the subset of converting users whose first interaction was an e-mail referral to the subset of the users whose first interaction was an organic search.

### BRIEF DESCRIPTION OF THE DRAWINGS

The details of one or more embodiments of the subject matter described in this specification are set forth in the accompanying drawings and the description below.

Other features, aspects, and advantages of the subject matter will become apparent from the description, the drawings, and the claims.

FIG. 1 is a block diagram of an example environment in which an advertisement management system manages advertising services in accordance with an illustrative embodiment.

FIG. 2 is a flow diagram of a process for integrating user interaction log data in accordance with an illustrative embodiment.

FIG. 3 is a block diagram that illustrates user interaction data being updated during a user interaction log data integration process in accordance with an illustrative embodiment.

FIG. 4a illustrates an example conversion path with a first interaction, assist interactions, and a last interaction.

FIG. 4b shows the determination of the path length based on the user interactions from FIG. 4a.

FIG. 4c shows the time lag from the first user interaction to the conversion based on the user interactions from FIG. 4a.

FIG. 5 is an illustrative user interface of a display of assist interactions for a period of time.

FIG. 6 is an illustrative user interface for reports related to an example domain name.

FIG. 7 is an illustrative user interface that may be shown to the advertiser to create a new segment.

FIG. 8 is an illustrative user interface shown to the advertiser when the advertiser selects path interactions from FIG. 7.

FIG. 9 is an illustrative user interface generated when the advertiser selects first interaction from the path interaction menu from FIG. 8.

FIG. 10 is an illustrative user interface showing a source being selected as a traffic medium.

FIG. 11 is an illustrative user interface that is displayed when the add an AND statement option is selected in FIG. 10.

FIG. 12 is an illustrative user interface that is displayed when the add an OR statement option is selected in FIG. 11.

FIG. 13 is an illustrative user interface of the segment from FIG. 12.

FIG. 14 illustrates how two segments may be compared in a graphical and numerical formats.

FIG. 15 displays the conversion data for two segments and compares the conversion data using various path length metrics.

FIG. 16 is a block diagram of a computer system in accordance with an illustrative embodiment.

Like reference numbers and designations in the various drawings indicate like elements.

### DETAILED DESCRIPTION

Content providers (e.g., advertisers) may access various reports that disclose information regarding various user interactions with the content. Each user interaction can include a number of dimensions, which can contain data associated with the user interaction. Reports can be generated to provide a content provider (or advertiser) with information regarding the user interactions. Such reports can have a large number of unique user interactions. Rules can be generated that group various user interactions that satisfy various group rules. Reports can be generated which include the various grouped user interactions. The user interactions may include conversion path data that comprises the source/medium that a user used to access the content provider's content.

As used throughout this document, user interactions include any presentation of content to a user and any subsequent affirmative actions or non-actions (collectively referred to as “actions” unless otherwise specified) that a user takes in response to presentation of content to the user (e.g., selections of the content following presentation of the content, or non-selections of the content following the presentation of the content). Thus, a user interaction does not necessarily require a selection of the content (or any other affirmative action) by the user. For example, the user reviewing content for a period of time may be considered an interaction. A user interaction may also include a user typing in the URL of a content provider directly into the web browser.

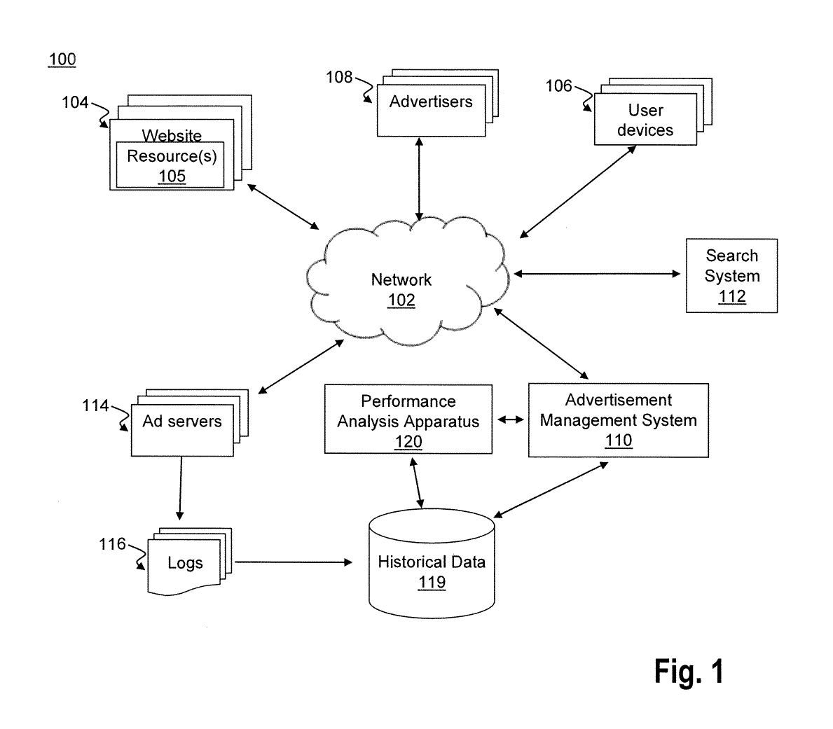

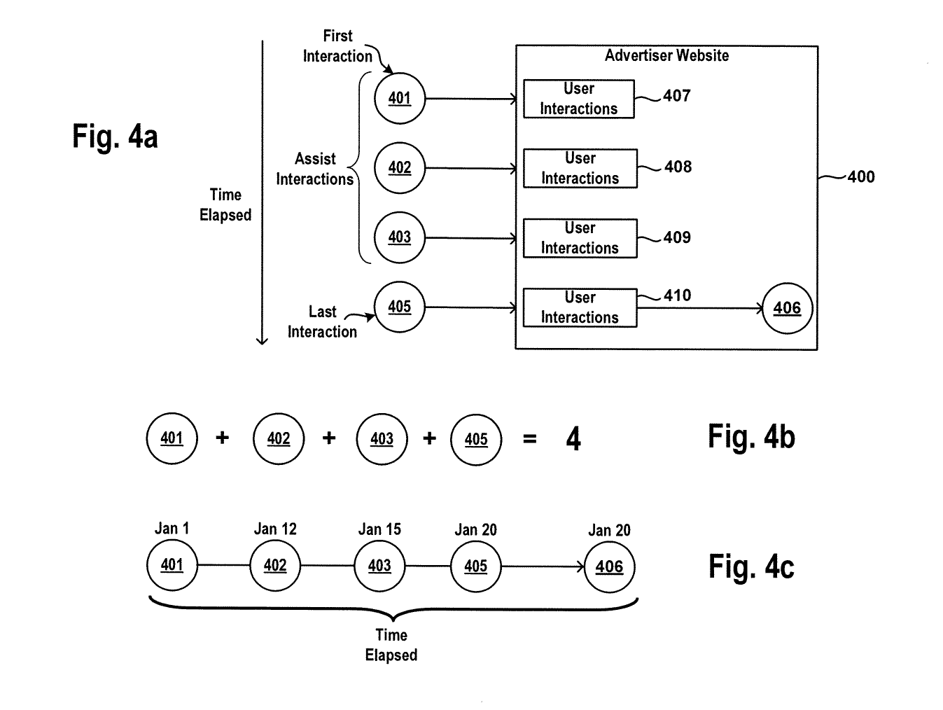

An analysis tool (i.e. performance analysis apparatus 120 of FIG. 1) may analyze conversion path data to assist an advertiser to determine an effective advertising strategy. The analysis and reports of the conversion path data can enable an advertiser to make advertising budget allocation decisions. The advertising decisions may lead to a greater number of users reaching the advertiser's content. On many occasions, a user interaction with the advertiser's content may not initially lead to a conversion action by the user. The user may review the content many times prior to performing a conversion action (See, FIGS. 4a-c). Embodiments of the analysis tool provide the ability to segment the conversion path data based on dimensions and metrics related to conversion path attributes. A path-level dimension (dimension) may represent one or more characteristics of one or more interactions that are part of a conversion path. A dimension may be a variable that is assigned a character or string value based on the characteristics of the user interaction with the advertiser's content. A path-level metric (metric) may include a numerical characteristic of the entire conversion path. A metric may be a variable that is assigned an integer or floating value that characterizes the entire conversion path.

In particular, the analysis tool may allow an advertiser to segment the conversion path data based on the path or paths traversed by a user in navigating to the advertiser's content. Embodiments of the analysis tool may focus on the user interactions that occurred just prior to the user accessing the advertiser's website. In another embodiment, the analysis tool may track or analyze all user interactions prior to the latest conversion, including, interaction with the content provider's website. (e.g. repeat customers or the like) For example, an advertiser may use a plurality of marketing channels (search terms, social media, e-mail campaigns, or the like) to drive the user traffic to their site, leading to desired user actions on their website (i.e. conversions). The analysis tool may identify the marketing channel that drove the users to the online content. Moreover, the analysis tool may attribute additional information to a user interaction (e,g., a first interaction label, an assist interaction label, a last interaction label, path length information, time lag information, or the like).

User interaction measures can include one or more of time lag measures (i.e., measures of time from one or more specified user interactions to a conversion), path length measures (i.e., quantities of user interactions that occurred prior to conversions), user interaction paths (i.e., sequences of user interactions that occurred prior to the conversion), assist interaction measures (i.e., quantities of particular user interactions that occurred prior to the conversion), and assisted conversion measures (i.e., quantities of conversions that were assisted by specified content).

FIG. 1 is a block diagram of an example environment in which an advertisement management system manages advertising services in accordance with an illustrative embodiment. The example environment 100 includes a network 102, such as a local area network (LAN), a wide area network (WAN), the Internet, or a combination thereof. The network 102 connects websites 104, user devices 106, advertisers 108, and an advertisement management system 110. The example environment 100 may include many thousands of websites 104, user devices 106, and advertisers 108.

A website 104 includes one or more resources 105 associated with a domain name and hosted by one or more servers. An example website is a collection of web pages formatted in hypertext markup language (HTML) that can contain text, images, multimedia content, and programming elements, such as scripts.

A resource 105 is any data that can be provided over the network 102. A resource 105 is identified by a resource address that is associated with the resource 105, such as a uniform resource locator (URL). Resources 105 can include web pages, word processing documents, portable document format (PDF) documents, images, video, programming elements, interactive content, and feed sources, to name only a few. The resources 105 can include content, such as words, phrases, images and sounds, that may include embedded information (such as meta-information in hyperlinks) and/or embedded instructions. Embedded instructions can include code that is executed at a user's device, such as in a web browser. Code can be written in languages, such as, JavaScript® or ECMAScript®.

A user device 106 is an electronic device that is under control of a user and is capable of requesting and receiving resources 105 over the network 102. Example user devices 106 include personal computers, mobile communication devices, and other devices that can send and receive data over the network 102. A user device 106 typically includes a user application, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can include data specifying a portion of the resource or a portion of a user display (e.g., a presentation location of a pop-up window or in a slot of a web page) in which advertisements can be presented. These specified portions of the resource 105 or user display are referred to as advertisement slots.

To facilitate searching of the vast number of resources 105 accessible over the network 102, the environment 100 can include a search system 112 that identifies the resources 105 by crawling and indexing the resources 105 provided on the websites 104. Data about the resources 105 can be indexed based on the resource 105 with which the data is associated. The indexed and, optionally, cached copies of the resources 105 are stored in a search index (not shown).

User devices 106 can submit search queries to the search system 112 over the network 102. In response, the search system 112 accesses the search index to identify resources 105 that are relevant to the search query. In one illustrative embodiment, a search query includes one or more keywords. The search system 112 identifies the resources 105 that are responsive to the query, provides information about the resources 105 in the form of search results and returns the search results to the user devices 106 in search results pages. A search result can include data generated by the search system 112 that identifies a resource 105 that is responsive to a particular search query, and can include a link to the resource 105. An example search result can include a web page title, a snippet of text or a portion of an image extracted from the web page 104, a rendering of the resource 105, and the URL of the web page 104. Search results pages can also include one or more advertisement slots in which advertisements can be presented.

A search result page can be sent with a request from the search system 112 for the web browser of the user device 106 to set an HTTP (HyperText Transfer Protocol) cookie. A cookie can represent, for example, a particular user device 106 and a particular web browser. For example, the search system 112 includes a server that replies to the query by sending the search results page in an HTTP response. This HTTP response includes instructions (e.g., a set cookie instruction) that cause the browser to store a cookie for the site hosted by the server or for the domain of the server. If the browser supports cookies and cookies are enabled, every subsequent page request to the same server or a server within the domain of the server will include the cookie. The cookie can store a variety of data, including a unique or semi-unique identifier. The unique or semi-unique identifier can be anonymized and is not connected with user names. Because HTTP is a stateless protocol, the use of cookies allows an external service, such as the search system 112 or other system, to track particular actions and status of a user over multiple sessions. A user may opt out of tracking user actions, for example, by disabling cookies in the browser's settings.

When a resource 105 or search results are requested by a user device 106 or provided to the user device 106, the advertisement management system 110 receives a request for advertisements to be provided with the resource 105 or search results. The request for advertisements can include characteristics of the advertisement slots that are defined for the requested resource 105 or search results page, and can be provided to the advertisement management system 110. For example, a reference (e.g., URL) to the resource 105 for which the advertisement slot is defined, a size of the advertisement slot, and/or media types that are available for presentation in the advertisement slot can be provided to the advertisement management system 110. Similarly, keywords (i.e., one or more words that are associated with content) associated with a requested resource 105 (“resource keywords”) or a search query for which search results are requested can also be provided to the advertisement management system 110 to facilitate identification of advertisements that are relevant to the resource 105 or search query.

Based on data included in the request for advertisements, the advertisement management system 110 can select advertisements that are eligible to be provided in response to the request (“eligible advertisements”). For example, eligible advertisements can include advertisements having characteristics matching the characteristics of advertisement slots and that are identified as relevant to specified resource keywords or search queries. In some implementations, advertisements having targeting keywords that match the resource keywords, the search query, or portions of the search query are selected as eligible advertisements by the advertisement management system 110.

The advertisement management system 110 selects an eligible advertisement for each advertisement slot of a resource 105 or of a search results page. The resource 105 or search results page is received by the user device 106 for presentation by the user device 106. User interaction data representing user interactions with presented advertisements can be stored in a historical data store 119. For example, when an advertisement is presented to the user via an ad server 114, data can be stored in a log file 116. This log file 116, as more fully described below, can be aggregated with other data in the historical data store 119. Accordingly, the historical data store 119 contains data representing the advertisement impression. For example, the presentation of an advertisement is stored in response to a request for the advertisement that is presented. For example, the ad request can include data identifying a particular cookie, such that data identifying the cookie can be stored in association with data that identifies the advertisement(s) that were presented in response to the request. In some implementations, the data can be stored directly to the historical data store 119.

Similarly, when a user selects (i.e., clicks) a presented advertisement, data representing the selection of the advertisement can be stored in the log file 116, a cookie, or the historical data store 119. In some implementations, the data is stored in response to a request for a web page that is linked to by the advertisement. For example, the user selection of the advertisement can initiate a request for presentation of a web page that is provided by (or for) the advertiser. The request can include data identifying the particular cookie for the user device, and this data can be stored in the advertisement data store.

User interaction data can be associated with unique identifiers that represent a corresponding user device with which the user interactions were performed. For example, in some implementations, user interaction data can be associated with one or more cookies. Each cookie can include content which specifies an initialization time that indicates a time at which the cookie was initially set on the particular user device 106.

The log files 116, or the historical data store 119, also store references to advertisements and data representing conditions under which each advertisement was selected for presentation to a user. For example, the historical data store 119 can store targeting keywords, bids, and other criteria with which eligible advertisements are selected for presentation. Additionally, the historical data store 119 can include data that specifies a number of impressions for each advertisement and the number of impressions for each advertisement can be tracked, for example, using the keywords that caused the advertisement impressions and/or the cookies that are associated with the impressions. Data for each impression can also be stored so that each impression and user selection can be associated with (i.e., stored with references to and/or indexed according to) the advertisement that was selected and/or the targeting keyword that caused the advertisement to be selected for presentation.

The advertisers 108 can submit, to the advertisement management system 110, campaign parameters (e.g., targeting keywords and corresponding bids) that are used to control distribution of advertisements. The advertisers 108 can access the advertisement management system 110 to monitor performance of the advertisements that are distributed using the campaign parameters. For example, an advertiser can access a campaign performance report that provides a number of impressions (i.e., presentations), selections (i.e., clicks), and conversions that have been identified for the advertisements. The campaign performance report can also provide a total cost, a cost-per-click, and other cost measures for the advertisement over a specified period of time. For example, an advertiser may access a performance report that specifies that advertisements distributed using the phrase match keyword “hockey” have received 1,000 impressions (i.e., have been presented 1,000 times), have been selected (e.g., clicked) 20 times, and have been credited with 5 conversions. Thus, the phrase match keyword hockey can be attributed with 1,000 impressions, 20 clicks, and 5 conversions.

As described above, reports that are provided to a particular content provider can specify performance measures measuring user interactions with content that occur prior to a conversion. A conversion occurs when a user performs a specified action, and a conversion path includes a conversion and a set of user interactions occurring prior to the conversion by the user. Any “recordable” user interaction or user interactions can be deemed a conversion. For example, dialing a phone number displayed on a website may be a conversion and may be tracked. What constitutes a conversion may vary from case to case and can be determined in a variety of ways. For example, a conversion may occur when a user clicks on an advertisement, is referred to a web page or website, and then consummates a purchase there before leaving the web page or website. As another example, a conversion may occur when a user spends more than a given amount of time on a particular website. Data from multiple user interactions can be used to determine the amount of time at the particular website.

Actions that constitute a conversion can be specified by each advertiser. For example, each advertiser can select, as a conversion, one or more measurable/observable user actions such as, for example, downloading a white paper, navigating to at least a given depth of a website, viewing at least a certain number of web pages, spending at least a predetermined amount of time on a website or web page, or registering on a website. Other actions that constitute a conversion can also be used.

To track conversions (and other interactions with an advertiser's website), an advertiser can include, in the advertiser's web pages, embedded instructions that monitor user interactions (e.g., page selections, content item selections, and other interactions) with advertiser's website, and can detect a user interaction (or series of user interactions) that constitutes a conversion. In some implementations, when a user accesses a web page, or another resource, from a referring web page (or other resource), the referring web page (or other resource) for that interaction can be identified, for example, by execution of a snippet of code that is referenced by the web page that is being accessed and/or based on a URL that is used to access the web page.

For example, a user can access an advertiser's website by selecting a link presented on a web page, for example, as part of a promotional offer by an affiliate of the advertiser. This link can be associated with a URL that includes data (i.e., text) that uniquely identifies the resource from which the user is navigating. For example, the link http://www.example.com/homepage/%affiliate_identifier%promotion_{—}1 specifies that the user navigated to the example.com web page from a web page of the affiliate that is associated with the affiliate identifier number that is specified in the URL, and that the user was directed to the example.com web page based on a selection of the link that is included in the promotional offer that is associated with promotion_{—}1. The user interaction data for this interaction (i.e., the selection of the link) can be stored in a database and used, as described below, to facilitate performance reporting.

When a conversion is detected for an advertiser, conversion data representing the conversion can be transmitted to a data processing apparatus (“analytics apparatus”) that receives the conversion data, and in turn, stores the conversion data in a data store. This conversion data can be stored in association with one or more cookies for the user device that was used to perform the user interaction, such that user interaction data associated with the cookies can be associated with the conversion and used to generate a performance report for the conversion.

Typically, a conversion is attributed to a targeting keyword when an advertisement that is targeted using the targeted keyword is the last clicked advertisement prior to the conversion. For example, advertiser X may associate the keywords “tennis,” “shoes,” and “Brand-X” with advertisements. In this example, assume that a user submits a first search query for “tennis,” the user is presented a search result page that includes advertiser X's advertisement, and the user selects the advertisement, but the user does not take an action that constitutes a conversion. Assume further that the user subsequently submits a second search query for “Brand-X,” is presented with the advertiser X's advertisement, the user selects advertiser X's advertisement, and the user takes action that constitutes a conversion (e.g., the user purchases Brand-X tennis shoes). In this example, the keyword “Brand-X” will be credited with the conversion because the last advertisement selected prior to the conversion (“last selected advertisement”) was an advertisement that was presented in response to the “Brand-X” being matched.

Providing conversion credit to the keyword that caused presentation of the last selected advertisement (“last selection credit”) prior to a conversion is a useful measure of advertisement performance, but this measure alone does not provide advertisers with data that facilitates analysis of a conversion cycle that includes user exposure to, and/or selection of, advertisements prior to the last selected advertisement. For example, last selection credit measures alone do not specify keywords that may have increased brand or product awareness through presentation of advertisements that were presented to, and/or selected by, users prior to selection of the last selected advertisement. However, these advertisements may have contributed significantly to the user subsequently taking action that constituted a conversion.

In the example above, the keyword “tennis” is not provided any credit for the conversion, even though the advertisement that was presented in response to a search query matching the keyword “tennis” may have contributed to the user taking an action that constituted a conversion (e.g., making a purchase of Brand-X tennis shoes). For instance, upon user selection of the advertisement that was presented in response to the keyword “tennis” being matched, the user may have viewed Brand-X tennis shoes that were available from advertiser X. Based on the user's exposure to the Brand-X tennis shoes, the user may have subsequently submitted the search query “Brand-X” to find the tennis shoes from Brand-X. Similarly, the user's exposure to the advertisement that was targeted using the keyword “tennis,” irrespective of the user's selection of the advertisement, may have also contributed to the user subsequently taking action that constituted a conversion (e.g., purchasing a product from advertiser X). Analysis of user interactions, with an advertiser's advertisements (or other content), that occur prior to selection of the last selected advertisement can enhance an advertiser's ability to understand the advertiser's conversion cycle.

A conversion cycle is a period that begins when a user is presented an advertisement and ends at a time at which the user takes action that constitutes a conversion. A conversion cycle can be measured and/or constrained by time or actions and can span multiple user sessions. User sessions are sets of user interactions that are grouped together for analysis. Each user session includes data representing user interactions that were performed by a particular user and within a session window (i.e., a specified period). The session window can be, for example, a specified period of time (e.g., 1 hour, 1 day, or 1 month) or can be delineated using specified actions. For example, a user search session can include user search queries and subsequent actions that occur over a 1 hour period and/or occur prior to a session ending event (e.g., closing of a search browser).

Analysis of a conversion cycle can enhance an advertiser's ability to understand how its customers interact with advertisements over a conversion cycle. For example, if an advertiser determines that, on average, an amount of time from a user's first exposure to an advertisement to a conversion is 20 days, the advertiser can use this data to infer an amount of time that users spend researching alternative sources prior to converting (i.e., taking actions that constitute a conversion). Similarly, if an advertiser determines that many of the users that convert do so after presentation of advertisements that are targeted using a particular keyword, the advertiser may want to increase the amount of money that it spends on advertisements distributed using that keyword and/or increase the quality of advertisements that are targeted using that particular keyword.

Measures of user interactions that facilitate analysis of a conversion cycle are referred to as conversion path performance measures. A conversion path is a set of user interactions by a particular user prior to and including a conversion by the particular user. Conversion path performance measures specify durations of conversion cycles, numbers of user interactions that occurred during conversion cycles, paths of user interactions that preceded a conversion, numbers of particular user interactions that occurred preceding conversions, as well as other measures of user interaction that occurred during conversion cycles, as described in more detail below.

The advertisement management system 110 includes a performance analysis apparatus 120 that determines conversion path performance measures that specify measures of user interactions with content items during conversion cycles. The performance analysis apparatus 120 tracks, for each advertiser, user interactions with advertisements that are provided by the advertiser, determines (i.e., computes) one or more conversion path performance measures, and provides data that cause presentation of a performance report specifying at least one of the conversion path performance measures. Using the performance report, the advertiser can analyze its conversion cycle, and learn how each of its keywords cause presentation of advertisements that facilitate conversions, irrespective of whether the keywords caused presentation of the last selected advertisement. In turn, the advertiser can adjust campaign parameters that control distribution of its advertisements based on the performance report.

Configuration options can be offered to reduce bias in performance reports. Without configuration options, some performance reports can be biased, such as towards short conversion paths. For example, a performance report can be biased towards short conversion paths if data used as a basis for the report includes a percentage of partial conversion paths. A partial conversion path is a conversion path in which some but not all user interaction data for a user is associated with a conversion. A partial conversion path can be included in a report if, for example, the report is generated using a reporting period which is less then the length of a typical conversion cycle for the advertiser who requested the report.

A reporting period determines the maximum length (in days) of a reported conversion cycle because additional data outside of the reporting period is not used to generate the report. A performance report can be based on a reporting period (i.e., lookback window), such that user interactions prior to the reporting period are not considered part of the conversion cycle when generating the report. Such a reporting period is referred to as a “lookback window”. For example, when generating a report with a lookback window of thirty days, available user interaction data representing user actions that occurred between July 1 and July 31 of a given year would be available for a conversion that occurred on July 31 of that year.

If a default lookback window (e.g., thirty days) is used, the performance report can be biased towards short conversion paths if the typical conversion cycle length for a product associated with the report is greater than the default lookback window. For instance, in the example above, a typical conversion cycle for “Brand-X” tennis shoes may be relatively short (e.g., thirty days) as compared to a conversion cycle for a more expensive product, such as a new car. A new car may have a much longer conversion cycle (e.g., ninety days).

Different advertisers or different products for an advertiser can have different associated conversion cycle lengths. For example, an advertiser that sells low cost (e.g., less than $100) products may specify a lookback window of 30 days, while an advertiser that sells more expensive products (e.g., at least $1000) may specify a lookback window of 90 days.

In some implementations, an advertiser 108 can specify a lookback window to use when requesting a performance report, such as by entering a number of days or by selecting a lookback window from a list of specific lookback windows (e.g., thirty days, sixty days, ninety days). Allowing an advertiser to configure the lookback window of their performance reports enables the advertiser to choose a lookback window that corresponds to conversion cycles of their products. Allowing lookback window configuration also enables advertisers to experiment with different lookback windows, which can result in the discovery of ways to improve conversion rates.

Other factors can contribute to reporting on partial conversion paths. For example, as mentioned above, user interaction data used as a basis for a report can be associated with unique identifiers that represent a user device with which the user interactions were performed. As described above, a unique identifier can be stored as a cookie. Cookies can be deleted from user devices, such as by a user deleting cookies, a browser deleting cookies (e.g., upon browser exit, based on a browser preference setting), or some other software (e.g., anti-spyware software) deleting cookies.

If cookies are deleted from a user device, a new cookie will be set on the user's device when the user visits a web page (e.g., the search system 112). The new cookie may be used to store a new quasi-unique identifier, and thus subsequent user interaction data that occurs on the user device may be associated with a different identifier. Therefore, because each user identifier is considered to represent a different user, the user interaction data associated with the deleted cookies are identified as being associated with a different user than the user interaction data that is associated with the new cookies.

For instance, in the example above, assume that the user deletes cookies after the first search query for “tennis” is performed and that the second search query for “Brand-X” occurs after the cookies are deleted. In this example, performance measures computed based on the user interaction data for the user can show a bias. For example, a path length measure can be computed as one, rather than two, since the advertisement selection resulting from the first search query is not considered part of the same conversion cycle as the advertisement selection resulting from the second search query, since the two user interactions do not appear to have been performed by the same user.

To view a report which reduces bias caused from partial conversion paths, an advertiser can specify a lookback window for the report. As described above, the lookback window specifies that the user interaction data used to generate the report are user interaction data that are associated with unique identifiers that have initialization times that are prior to a specified period (e.g., thirty days, sixty days, ninety days) before the conversions. Thus, conversions for which user interaction data that are associated with unique identifiers having initialization times that are after the specified period are excluded from inclusion as a basis for the report. A unique identifier that has a recent initialization time indicates that the unique identifier may have been recently reinitialized on the user device that the unique identifier represents. Accordingly, user interaction data associated with the relatively new unique identifier may represent only a partial conversion path. Alternatively, conversions for which user interaction data that are associated with unique identifiers having initialization times that are after the specified period are included in the report. To reduce bias, any user interaction included in the conversion path that occurred after the specified period are removed from the conversion path prior to being included in the report.

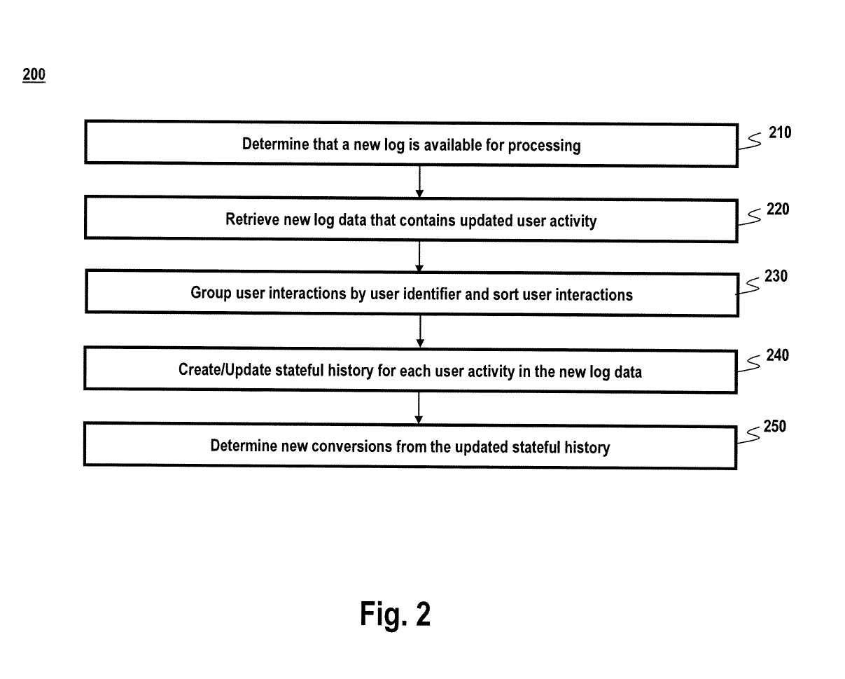

FIG. 2 is a flow diagram of a process for integrating user interaction log data in accordance with an illustrative embodiment. The process 200 is a process that updates conversion paths and determines conversions based upon the updated conversion paths of users.

The process 200 can be implemented on the advertisement management system 110, the performance analysis apparatus 120, or another computing device. In one implementation, the process 200 is encoded on a computer-readable medium that contains instructions that when executed by a computing device cause the computing device to perform operations of process 200.

As described above, log files 116 may contain user interaction data. A log file 116 may be combined with user interaction data from other logs from other servers, including those that implement the search system 112, prior to processing. Processing starts with the computing device that implements the process 200 that determines that a new log is available for processing (210). For example, a notification can be sent to the computing device indicating that a new log is ready for processing, or the existence of a new log can indicate that the new log is ready for processing.

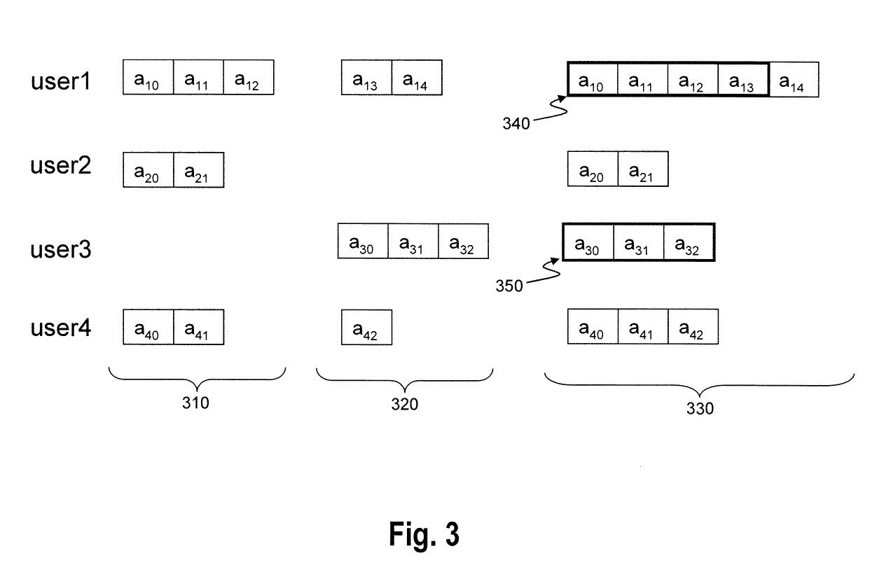

Next, the new log is retrieved (220). The new log may be retrieved over the network 102. The stateful history for each user is updated based upon the user activity indicated by the new log. The new log can contain information relating to user interactions for numerous users. The historical data store 119 contains user interaction data from previously processed log files. The user interaction data contained within the historical data store 119 can be stateful, in that the user interaction data can be grouped by user identifier and ordered chronologically. FIG. 3 is a block diagram that illustrates user interaction data being updated during a user interaction log data integration process 200 in accordance with an illustrative embodiment. FIG. 3 illustrates four example user identifiers, although the historical data store 119 and log files 116 can contain data associated with thousands or millions of different user identifiers. In one embodiment, previously stored user interaction data 310 are stored in the historical data store 119. As illustrated, no user interaction data associated with user identifier 3 has been previously stored in the historical data store 119.

The new log can contain user interaction data for one or more user identifiers. The user interaction data can be grouped by user identifiers and then sorted chronologically (230). Column 320 illustrates grouped and sorted user interaction data. As illustrated, user identifier 2 does not include any new user interaction data, and user identifiers 1, 3, and 4 have updated user interaction data. For instance, the new log file includes user interaction data associated with user interactions a₁₃ and a₁₄ that are associated with user identifier 1. The grouped and sorted user interaction data can then merged with the user interaction data stored in the historical data store 119 (240). If a user identifier previously existed in the historical data store 119, the new user interaction data are added to the previous user interaction data. Otherwise, the new user interaction data is added with a new user identifier.

Column 330 illustrates the updated user interaction data for each of the user identifiers. Based upon the updated user interaction data, any conversions that occurred in each of the updated paths of user interactions can be determined (250). User interaction paths are constrained to those user interactions that are related to a particular advertiser 108. The conversion interactions of the particular advertiser 108 are used to determine if a conversion has occurred. As an example, assume that user interactions a₁₃ and a₃₂ represent conversion interactions. Accordingly, conversion paths 340 and 350 are found. Once found, the conversion paths can be written to another portion of the historical data store 119 or another data store for further analysis.

Each user interaction includes a set of data or dimensions associated with the user interaction. The dimensions can be sparsely populated, such that, any user interaction may have data relating to a subset of the dimensions. A large number of conversion paths can be generated based upon received user interaction data. Various reports regarding how a campaign or an advertiser's placements are performing can include various information regarding the conversion paths. Given the large potential number of conversion paths, various conversion paths can be grouped together to reduce the number of distinct conversion paths that are reported. In an illustrative embodiment, conversion paths that have the same number of user interactions and have corresponding data can be aggregated.

Dimensional data of user interactions can be sparsely populated. Using a single dimension to aggregate conversion paths can result in a large number of aggregated conversion paths that do not have data associated with the aggregated dimension. In an illustrative embodiment, multiple dimensions can be used to aggregate various conversion paths. A sorted list of dimensions can be used to determine, for each user interaction, a first matching dimension that contains data. If there is no matching dimension for any particular user interaction a default dimension or data value can be specified. For instance, a default dimension that is not sparsely populated can be used as the default dimension or a text string, such as, “unavailable,” “(none),” or “ ” can be used as a default value.

Using the sorted list of dimensions, each conversion path can be converted into a dimensional path. A dimensional path contains dimensional elements that correspond to the user interactions of a conversion path. The dimensional element can contain or reference data from the first dimension that contains data from the corresponding user interaction. For instance, assume the sorted list of dimensions contains dimension₁, dimension₂, and dimension₃ and a user interaction contains data in dimension₂, and dimension₃ but not in dimension₁. A dimensional element corresponding to this user interaction would contain or reference the dimension₂ data from the user interaction, since dimension₂ was the first dimension of the user interaction that contained data. A dimension is not limited to having data from a single dimension. For instance, the data from multiple dimensions can be combined into a dimension. In addition, the dimensional element may contain additional information from the user interaction beyond the first matching dimension.

In one embodiment, conversion paths are converted into dimensional paths by adding a reference to the dimensional data to each of the user interactions. In another embodiment, dimensional paths that are separate from the conversion paths are created. In this embodiment, the dimensional paths can be stored in a location different from the location that stores the conversion paths. Regardless of how the dimensional paths are implemented, the dimensional paths can be aggregated based upon the length and the dimensional elements of the dimensional paths.

In one embodiment, the dimensional elements contain the dimensional data as well as other data from the corresponding user interaction. For example, a conversion interaction can include a value associated with the conversion. As the dimensional paths are aggregated, the value of all conversion paths associated with the aggregated dimensional paths can be also be aggregated. This aggregated value can be included in a report.

FIG. 4a illustrates an example conversion path. Initially a user may access the advertiser website 400 by performing a search in a search engine (i.e., search engine 1) and by selecting a sponsored link displayed within the search results. This type of interaction may be referred to as having the source: “search engine 1” and medium “cpc” (cost per click) or Search Engine 1/cpc 401. Accordingly, the first interaction between this user and the advertisers website 400 occurred by search engine 1/cpc 401. Since the user reached the advertiser website 400, the user may perform user interactions 407. The user transactions 407 may not lead to a conversion according to this example. Next, the user may be referred to the advertise website 400 by a social networking site 1/referral 402. After the referral the user may perform user interactions 408 which may not lead to an advertiser designated conversion. Next the user may reach the advertisers website 400 by conducting a search for the advertiser's trademark or domain name and selecting an organic search result, i.e. search engine 1/organic 403. After accessing the advertisers website 400 for the third time the user may perform interactions 409, which may not lead to a conversion. Since the user has been on this website three times the user may allow the browser to pull up the website directly on the fourth interaction, i.e. (none)/direct 405. Upon arriving at the advertiser website, the user may conduct various user interactions 410 which may lead to a conversion 406. In response to reaching a conversion the performance analysis apparatus 120 may determine that the conversion path includes a first interaction (search engine 1/cpc 401), second interaction (social networking site 1/referral 402), third interaction (search engine 1/organic 403), and fourth interaction (none/direct 405).

The performance analysis apparatus 120 may access historical data 119 to determine the conversion path that led the user to the advertiser's website. Moreover, the performance analysis apparatus 120 may designate attributions such as, first interaction, assist interactions, and last interaction to various nodes in the conversion path. For example, search engine 1/cpc 401 would be designated the first interaction since the user accessed the advertiser website 400 through search engine 1/cpc 401. The last interaction, would be none/direct 405 because it was the interaction that led to the conversion 406. All interactions other than the last interaction prior to reaching the advertiser's website would be referred to as assist interactions. Accordingly, in the example discussed in FIG. 4a, search engine 1/cpc 401, social networking site 1/referral 402, and search engine 1/organic 403 would be designated the attribution of the assist interactions. Also shown in FIG. 4a is the time period from the first interaction to the conversion 406.

FIG. 4b shows a calculation of the overall path length. Since there are 4 nodes 401, 402, 403 and 405 prior to the conversion the conversion path length for the example in FIG. 4a would be 4.

FIG. 4c shows the period of time that may have elapsed from the first interaction to the conversation 406. As shown in FIG. 4c the first interaction occurred on January 1, the second interaction occurred on January 12, the third interaction occurred on January 15, and the fourth interaction occurred on January 20. Accordingly, there was a 20 day time lag between the first interaction and the conversion. The analytic tool can determine that each of the four interactions were conducted by the same user and create a conversion path. In one embodiment, the interaction level attributes, the path length, time elapsed and other interaction related dimensions may be stored in an aggregate table. An advertiser may be able to segment the conversion data using interaction level filters or path level filters.

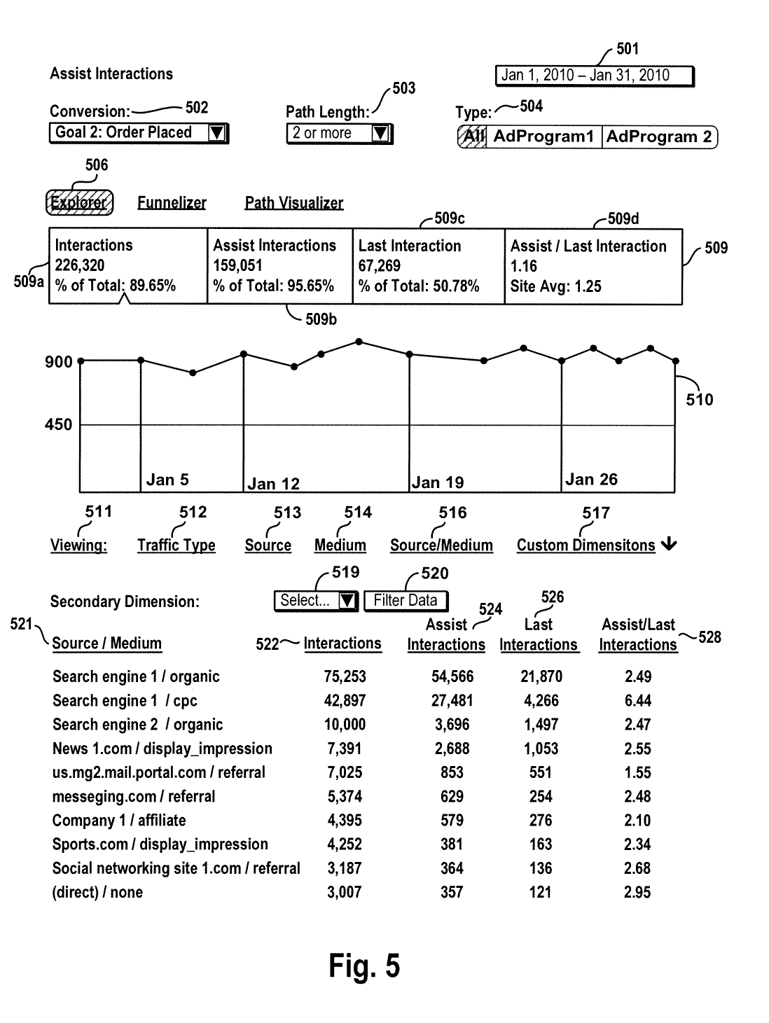

FIG. 5 is an illustration of an example display of an assist interaction summary for the time period 501 (i.e. Jan. 1, 2010-Jan. 31, 2010). The advertiser may choose a user specified conversion criteria 502. For example, in FIG. 5 the advertiser may have a goal 2 where the advertiser can segment the conversion path data based on whether the plurality of users placed an order. The display of FIG. 5 also allows a user to sort by path length 503. In this example the user specified the path length as 2 or more. The advertiser may choose to display the type 504 of the conversion path data. The types may comprise AdProgram1 assists or AdProgram2 for advertisers data. In the example shown in FIG. 5 the advertiser has chosen to display “all” types 504.

In the explorer view 506, the performance analysis apparatus 120 may generate and display the total percentage of interactions that meet the advertiser specified conversion criteria 502 and having path length 503. For example, the screen shot may display the total number of interactions 509a that meet the conversion goal and conversion path length criteria. Similar statistics (percentage of total number of interactions and the total number of assist interactions) may be displayed for assist interactions 509b and last interaction 509c. A ratio 509d compares the number of assist interactions for a dimension with the total number of last interactions for the dimension. Accordingly, if the ratio 509d is larger for a particular source, then the advertiser may want to spend extra funds to pursue the assist opportunity for the particular source. For example, assist/last interaction ratio 528 is displayed for various source/mediums in FIG. 5. Since source: search engine 1, and medium: cost per click (cpc) search engine 1/cpc has the highest ratio (i.e. “6.44”) among the displayed results, an advertiser may be informed that search engine 1/cpc may not be used as frequently for the last interactions. Nonetheless, many conversion paths use search engine 1/cpc as an assist and the advertiser may want to continue to spend funds to drive more users to their content because the assist interactions may lead to conversion interactions.

Chart 510 is displayed as a graphical representation of total number of interactions that meet the segmenting criteria (i.e., conversion goal 2: order placed combined with the path length 503 being “2 or more”). The y-axis for chart 510 shows the total number of interactions plotted over the time period 501. Accordingly, the advertiser may see how the total number of interactions was affected based on any changes made by the advertiser during the time period 501.

Other sorting and filtering criteria are also displayed in FIG. 5. For example, the advertiser may select to change the viewing 511, traffic type 512, source 513, medium 514, source/medium 516 or customer dimensions 517. The advertiser may choose to further filter or sort the data based on secondary dimensions chosen from a pull down menu 519. Alternatively or in addition, the advertiser may further filter the data using the filter button 520.

The display in FIG. 5 also allows a user to sort the data shown based on source/medium 521, interactions 522, assist interactions 524, last interactions 526 and assist divided by the last interactions 528. The sorting could be in ascending or descending order.

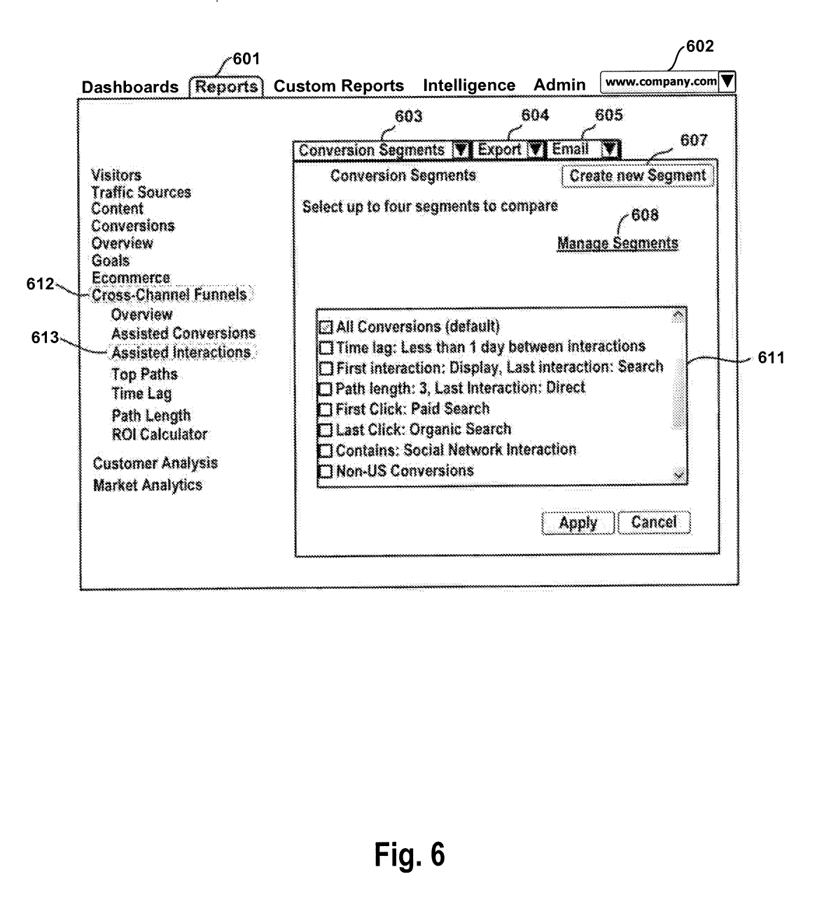

FIGS. 6 through 13 are illustrations of displays that show the flow for creating a cross-channel user defined segment for conversion path data. FIG. 6 shows a reports tab 601 related to an example domain www.company.com 602. The conversion segments 603 may be created from the cross-channel funnels 612 menu item and the assisted interactions 613 sub menu item. To create a new segment a user may click on the create new segment button 607. Some other options that may be presented to the advertiser may include a manage segments control 608 that allows a user to manage existing segments. Also shown are currently defined segments in a list box 611. Some of the segments include Time lag: less than 1 day between interactions and so on. An advertiser may choose to export the segment or the segment results to another application such as, a spreadsheet program, and the export menu button 604 may facilitate that functionality. An advertiser may choose to e-mail the results from a segment and the e-mail button 605 could access an e-mail program like to facilitate that functionality.

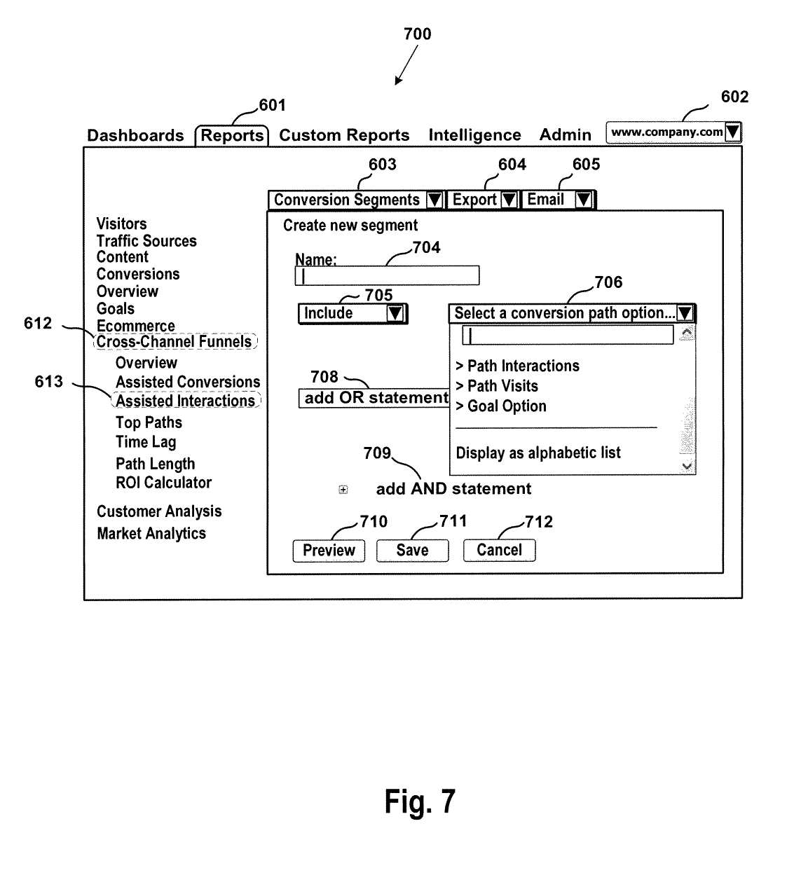

FIG. 7 shows an illustrative user interface 700 shown to the advertiser when the advertiser selects the create a new segment button 607 from FIG. 6. In the create a new segment interface 700 the advertiser may choose a name 704 for the segment. The “include” pull down option 705 allows an advertiser to include conversion path data or exclude conversion path data. A conversion path option menu 706 may provide the option of selecting at least one of a path interaction, path visit or goal option. An advertiser may add further conversion path segmentation by adding an OR statement using the button 708 or by adding an AND statement using the button 709. After specifying an expression or condition for the conversion path segment, the advertiser may preview the results using the preview 710 button, save the segment using the button 711 or cancel the segment using the button 712.

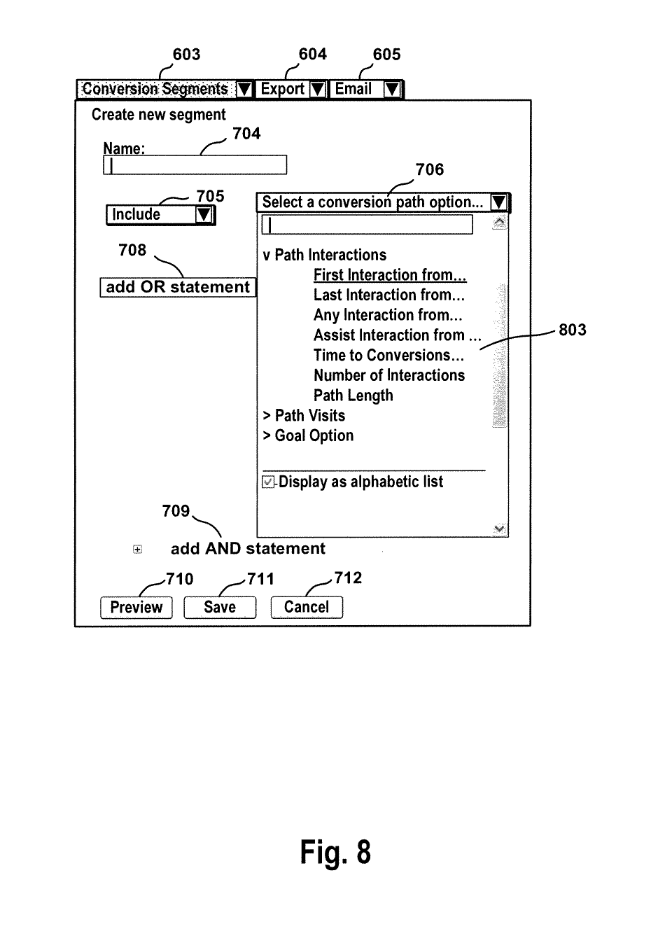

FIG. 8 is an illustrative user interface shown when the advertiser selects path interaction in the select a conversion path option menu 706. The path interaction selection 803 populates the screen with various path interaction dimensions, such as, first interaction from, last interaction from, time to conversions, number of interactions, path length and so on. The advertiser can select any one of these options to perform conversion path interaction segmenting.

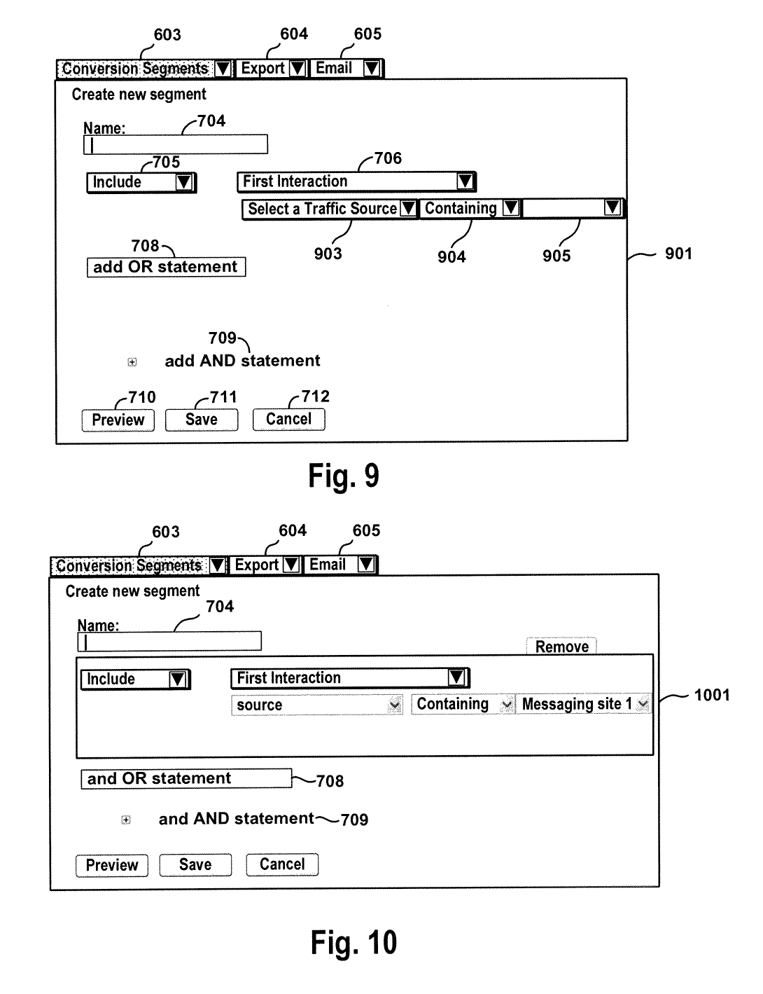

FIG. 9 is an illustrative user interface 901 that may be displayed when the advertiser selects a first interaction from the path interaction menu from FIG. 8. The advertiser may be presented with three more menu options relating to the first interaction, select a traffic source 903, containing or not containing 904 and text box or pull down menu 905. FIG. 10 is an illustrative user interface 1001 where source is selected as the dimension and the source contains the term “messaging site 1”. The segment may be saved or previewed. The results from this example segment would include all first interactions where messaging site 1 is the source for a conversion path.

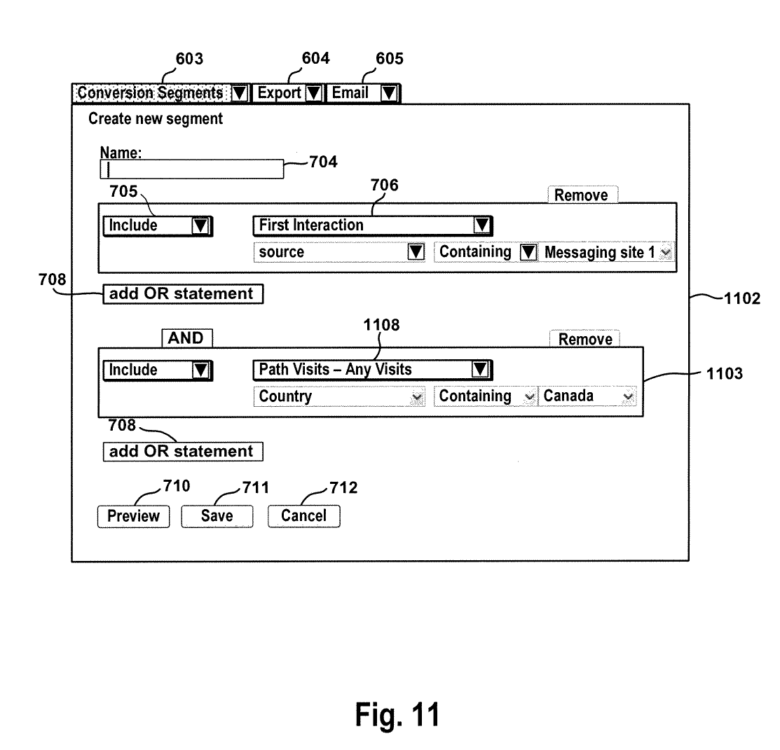

Referring to FIG. 11, FIG. 11 is an illustrative user interface 1102 that is displayed when the add an AND statement option button 709 is selected in FIG. 10. The AND statement 1103 may be added to the segment. The segment may be augmented to further filter the results to show the conversion data that includes path visits where any visit in the conversion path includes the country “Canada”. Accordingly, the resulting segment includes conversion path data for first interactions where the source is the messaging site 1 and paths with any visits from Canada. Creating a new segment screen allows the advertiser to add a greater number of and/or statements as desired.

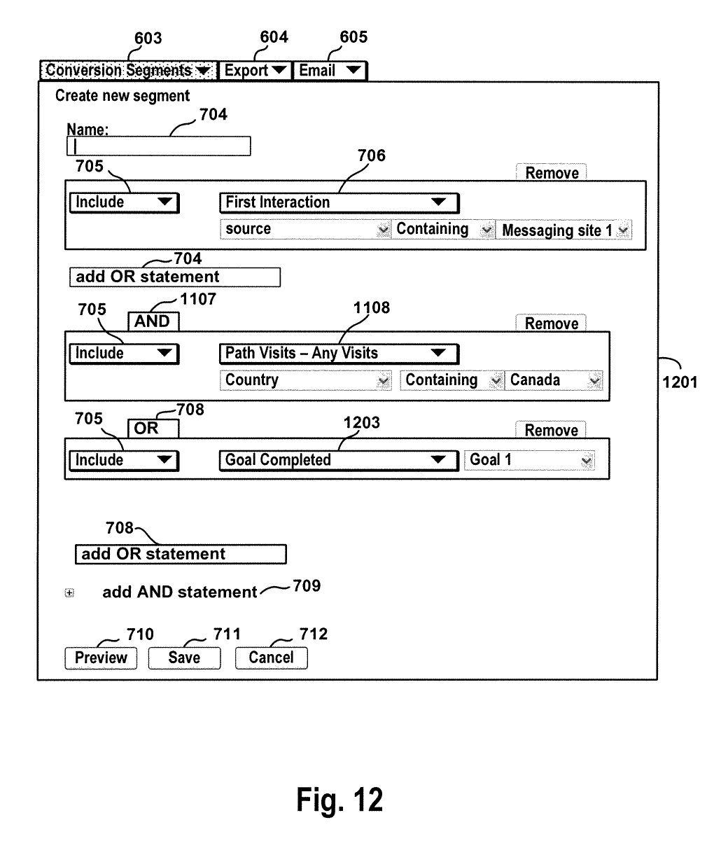

Referring to FIG. 12, FIG. 12 is an illustrative user interface 1201 that is displayed when the add an OR statement option is selected in FIG. 11. The OR statement may be added to the segment. The segment may be augmented to include the conversion path data where goal 1 was completed. The OR operator in this case will take precedence over the two statements that were connected by an AND operation. For example, the segment logic will resolve to A and (B or C), where A represents the first interactions with a messaging site 1 as the source, B represents any visits from Canada and C represents goal 1 having been completed.

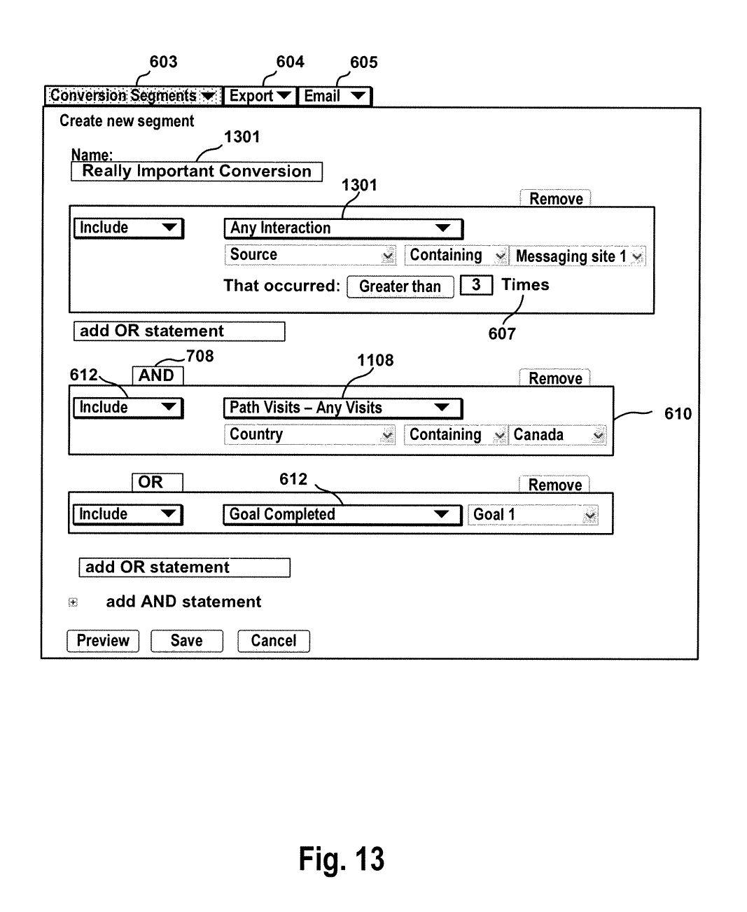

Referring to FIG. 13, FIG. 13 is an illustrative user interface of the segment from FIG. 12. In FIG. 13 the first interaction is amended to be any interaction and the any interaction is further modified to occur greater than 3 times. Accordingly, the segment has been modified to recite A′ and (B or C), where A′ represents any conversion path where the source messaging site 1 occurs more than 3 times. The dimensions and metrics disclosed in FIGS. 6-13 are one example of how an advertiser could create a segment. There are numerous other metrics and dimensions that an advertiser could use.

For example, an advertiser could create a positional segment that includes paths where a source/medium (e.g., search engine 1/cpc) interaction is followed by another source/medium (e.g., E-mail/referral) interaction. Another user defined segment could be defined such that a particular source or medium was not the first interaction (e.g., paths where the first interaction was not from “social networking site 1”).

Other conversion path based segments may contain an optional path-level filter representing conditions such as, the path must have a particular length (e.g., at least 3). In other embodiments, multiple conditions may be applied to a single interaction where two or more conditions have to match any one interaction (e.g., any one interaction matches source “search engine 1” and medium ‘organic” (as opposed to any interaction matching source “search engine 1” and any interaction matches medium “organic”)). Another embodiment of the segment may allow a condition to indicate a subsequent interaction relative to a previously matched interaction. Another embodiment of a segment may allow a strict positional limitation, such as a condition occurring immediately after or immediately before a source or medium or dimension or metric.

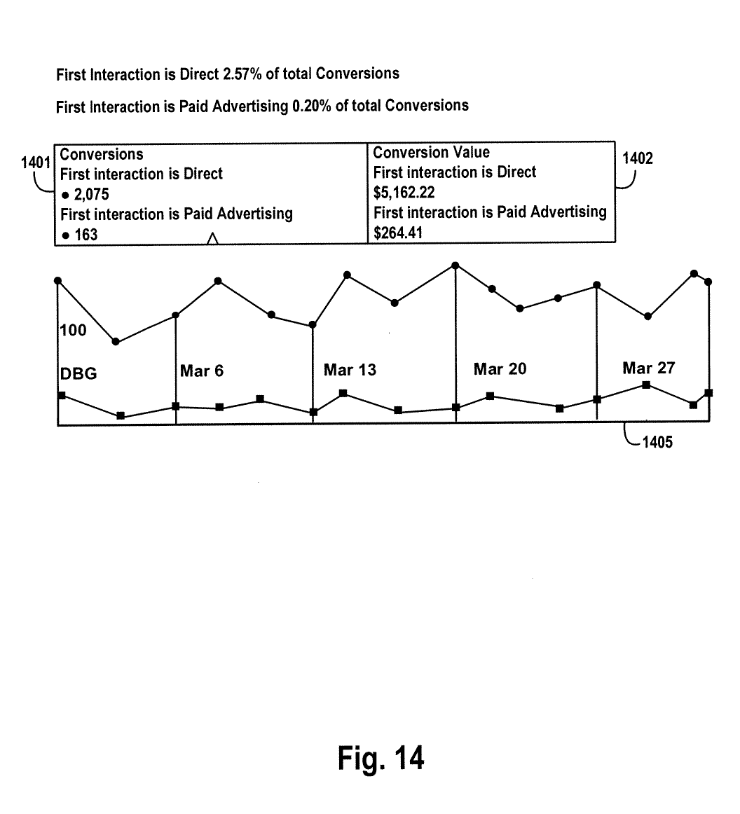

Referring to FIG. 14, FIG. 14 illustrates how two segments may be compared in a graphical and numerical manner. The first segment in this example has a condition that the first interaction in a conversion path is direct and the second segment has a condition that the first interaction in a conversion path is paid advertising. In the example shown in FIG. 14, the first segment led to 2.57% of the total conversions and the first interaction is paid advertising led to 0.2% of the total conversions. The numerical comparison is shown in box 1401. The numerical comparison discloses that the total number of first interactions that were direct equals “2075” and the total number of first interaction for the paid advertising equals “163”. The dollar amount of the conversions generated by each segment is compared in box 1402. The conversion data is further displayed as a line graph showing the first interaction is paid segment graphed over the first interaction is direct segment.

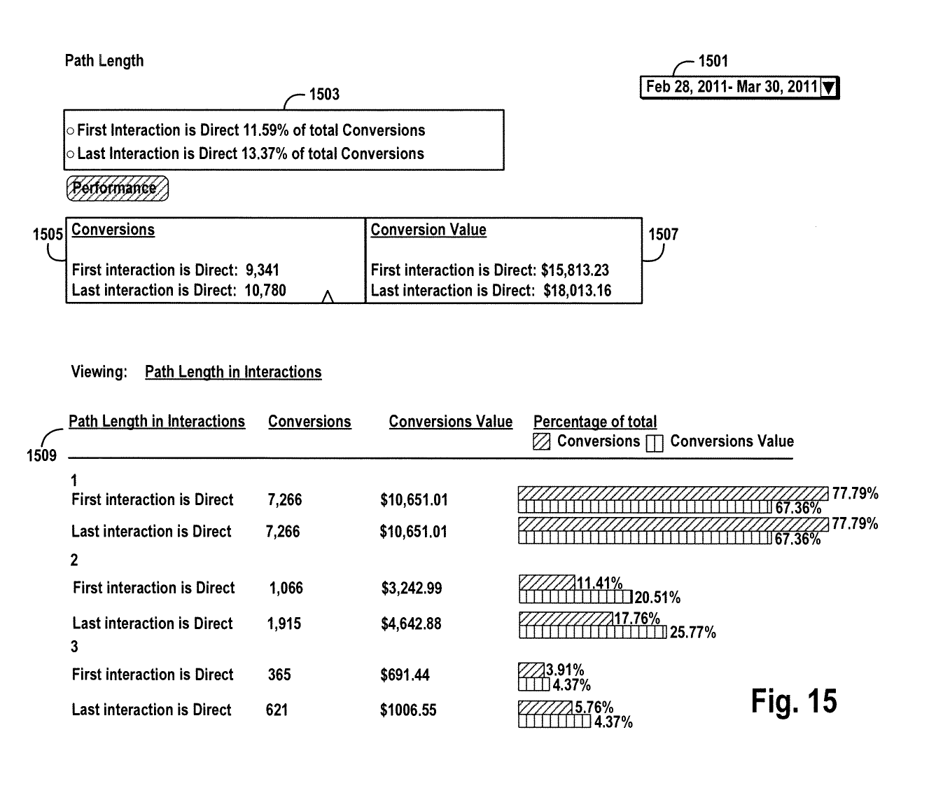

Referring to FIG. 15, FIG. 15 displays the conversion data for two segments and compares them using various path length metrics for a period of time 1501. The first segment in this example has the condition that the first interaction is direct and the second segment in this example has the condition that the last interaction is direct. Box 1501 shows a percentage comparison based on the total number of conversions. For example, the first segment is 11.59% of the total number of conversions compared to the second segment, which is 13.27% of the total number of conversions. Next, box 1505 recites the total number of conversions meeting the conditions of the first and second segments. The first segment has 9,341 conversions and the second segment has 10,780 conversions. Next, the conversion values for each segment are compared in box 1507, where the first segment has $15,813.23 and the second segment was attributed $18,013.16 in conversion value. Path length interactions 1409 for the first and the second segment are disclosed. Results for path length of 1, 2, and 3 are disclosed. Number of conversions, the value of the conversions and the percentage of total number of conversion may be displayed for each path length.

Conversion path based segmentation allows grouping of conversion paths based on conditions or filters that specify path-level dimensions and/or path level metrics. The resulting groups of conversion paths may be compared with other groups of conversion paths or excluded from the resulting view. Conversion path based segmentation allows an advertiser to define expressive conditions that may include custom dimensions that may be complex Boolean expressions of conversion path dimension or metrics.

Initially, the method for conversion path based segmentation may determine that a conversion has occurred. Next, using historical user interaction data, the method may determine how the user arrived at the advertisers website and how many times the user visited the advertisers website prior to the last interactions that lead to a conversion. The method may designate all earlier user interactions as assist interactions and may designate the latest interaction that led to the conversion as the last transaction. The data related to these designations may be stored in Reusable Aggregate Tables (RATs).

The method may provide a user interface to create expressive conditions that includes defining and reusing custom dimensions. The conditions may query the user interaction data to generate graphical and numerical results. Other related methods may create positional filters or segments, such as, the position of a particular source/medium in the conversion path relative to another source or medium. Other methods may allow a user to query using the length of the conversion path.

Aspects of the method described above have various advantages. For example, the new method enables advertisers to understand and draw conclusions about cross-channel advertising and return on investment. Advertisers can manipulate the reports using the method to examiner their conversion paths in ad-hoc ways. Rather than rely on pre-computed segments of conversion paths that are deemed interesting by the people designing the reports, advertisers can use the method to express the segments of their conversation paths that make the most sense for their business objectives, conversion cycles, or advertising strategies, etc. Advertisers can use the method to dig into previously inaccessible segments of their conversion path data. For example, users form Canada that were referred by a messaging service 1 where the conversion path length is 2 would be an express that could be created, however, creating this expression for all advertisers may be prohibitive.

The advertisement management system 110 and/or the performance analysis apparatus 120 can be realized by instructions that upon execution cause one or more processing devices to carry out the processes and functions described above. Such instructions can comprise, for example, interpreted instructions, such as script instructions, e.g., JavaScript® or ECMAScript® instructions, or executable code, or other instructions stored in a computer readable medium. The advertisement management system 110 and/or the performance analysis apparatus 120 can be distributively implemented over a network, such as a server farm, or can be implemented in a single computer device.

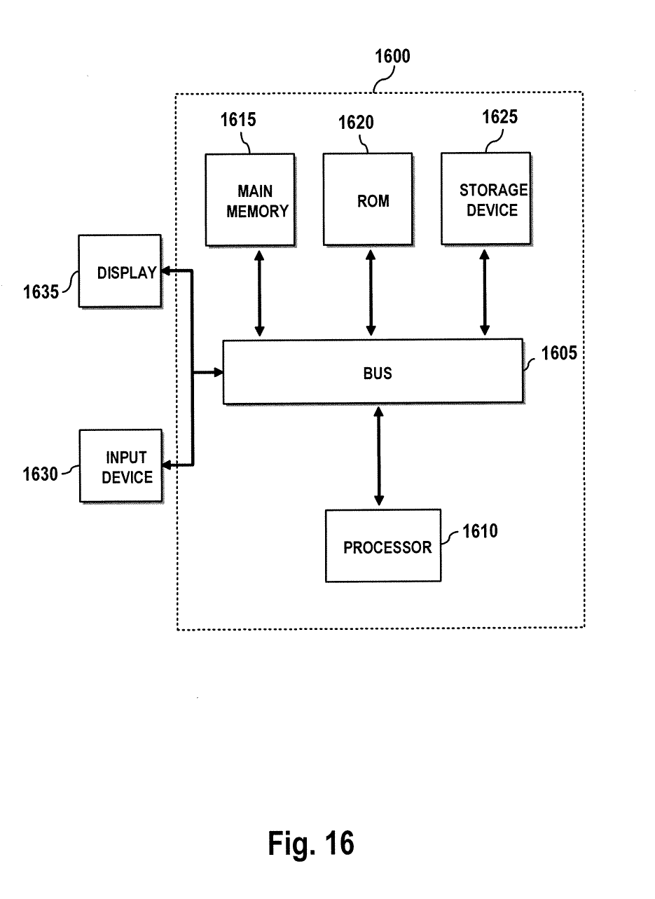

FIG. 16 illustrates a depiction of a computer system 1600 that can be used to provide user interaction reports, process log files, implement an illustrative performance analysis apparatus 120, or implement an illustrative advertisement management system 110. The computing system 1600 includes a bus 1605 or other communication mechanism for communicating information and a processor 1610 coupled to the bus 1605 for processing information. The computing system 1600 also includes main memory 1615, such as a random access memory (RAM) or other dynamic storage device, coupled to the bus 1605 for storing information, and instructions to be executed by the processor 1610. Main memory 1615 can also be used for storing position information, temporary variables, or other intermediate information during execution of instructions by the processor 1610. The computing system 1600 may further include a read only memory (ROM) 1610 or other static storage device coupled to the bus 1605 for storing static information and instructions for the processor 1610. A storage device 1625, such as a solid state device, magnetic disk or optical disk, is coupled to the bus 1605 for persistently storing information and instructions.

The computing system 1600 may be coupled via the bus 1605 to a display 1635, such as a liquid crystal display, or active matrix display, for displaying information to a user. An input device 1630, such as a keyboard including alphanumeric and other keys, may be coupled to the bus 1605 for communicating information, and command selections to the processor 1610. In another embodiment, the input device 1630 has a touch screen display 1635. The input device 1630 can include a cursor control, such as a mouse, a trackball, or cursor direction keys, for communicating direction information and command selections to the processor 1610 and for controlling cursor movement on the display 1635.

According to various embodiments, the processes that effectuate illustrative embodiments that are described herein can be implemented by the computing system 1600 in response to the processor 1610 executing an arrangement of instructions contained in main memory 1615. Such instructions can be read into main memory 1615 from another computer-readable medium, such as the storage device 1625. Execution of the arrangement of instructions contained in main memory 1615 causes the computing system 1600 to perform the illustrative processes described herein. One or more processors in a multi-processing arrangement may also be employed to execute the instructions contained in main memory 1615. In alternative embodiments, hard-wired circuitry may be used in place of or in combination with software instructions to implement illustrative embodiments. Thus, embodiments are not limited to any specific combination of hardware circuitry and software.

Although an example processing system has been described in FIG. 16, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving conversion path data that includes user interaction data;
assigning each interaction in the user interaction data one or more of a first interaction label, an assist interaction label and a last interaction label; and
grouping conversion path data according to at least one of a path-level dimension and a path-level metric.

2. The method of claim 1, wherein the conversion event is an interaction that satisfies one or more predetermined conversion criterion.

3. The method of claim 1,
wherein conversion path data comprises a plurality of conversion paths, wherein each conversion path includes user interaction data prior to and including the conversion event;
further comprising providing a user interface to define a condition to include or exclude a group of conversion paths.

4. The method of claim 1, wherein the assist interaction is any interaction by the user that occurs prior to the conversion event; wherein the last interaction is an interaction by the user immediately preceding the conversion event.

5. The method of claim 1, wherein the user interaction data includes a source and a medium used by the user to reach the content items.

6. The method of claim 1, wherein grouping the conversion path data includes filtering based on a particular type of interaction occurring prior to or after another type of interaction.

7. The method of claim 1, wherein grouping the conversion path data includes filtering based on a number of user interactions occurring prior to the conversion.

8. The method of claim 1, further comprising comparing one or more groups of conversion path data graphically and numerically.

9. The method of claim 1, further comprising determining a ratio of the assist interactions compared to the last interactions for a dimension.

10. The method of claim 1, wherein grouping conversion path data comprises defining a condition that is a Boolean expression that includes a plurality of conditions.

11. A system comprising:
one or more processors configured to:
receive conversion path data that includes user interaction data;
assign each interaction in the user interaction data one or more of a first interaction label, an assist interaction label or a last interaction label; and
group conversion path data according to at least one of a path-level dimension and a path-level metric.

12. The system of claim 11, wherein the conversion event is an interaction that satisfies one or more predetermined conversion criterion.

13. The system of claim 11,
wherein the conversion path data comprises a plurality of conversion paths, wherein each conversion path includes user interaction data prior to and including a conversion event;
wherein the one or more processors is configured to generate a user interface to define a condition to include or exclude a group of conversion paths.

14. The system of claim 11, wherein the one or more processors is configured to determine that the assist interaction is any interaction by the user that occurs prior to the conversion event; wherein the last interaction is the interaction by the user immediately preceding the conversion event.

15. The system of claim 11, wherein the user interaction data includes a source and a medium used by the user to reach the content items.

16. The system of claim 11, wherein grouping the conversion path data includes filtering based on a particular type of interaction occurring prior to or after another type of interaction.

17. The system of claim 11, wherein grouping the conversion path data includes filtering based on a number of user interactions occurring prior to the conversion.

18. The system of claim 11, wherein the one or more processors is configured to generate a display showing a comparison of one or more groups of conversion path data graphically and numerically.

19. The method of claim 9, further comprising determining a ratio of the assist interactions compared to the last interactions for a dimension.

20. A non-transitory computer implemented storage media configured to store a program product that, when executed on at least one processor performs a method comprising:
receiving conversion path data that includes user interaction data;
assigning each interaction in the user interaction data one or more of a first interaction label, an assist interaction label and a last interaction label; and
grouping conversion path data according to at least one of a path-level dimension and a path-level metric.
